(19) United States
(12) Patent Application Publication
(10) Pub. No.: US 2016/0018037 A1
(43) Pub. Date: Jan. 21, 2016

(54) Fluid Manifold Assembly

(71) Applicant: Colder Products Company, St. Paul, MN (US)

(72) Inventors: Jeremy Nichols, Maple Grove, MN (US); Andrew Quick, Circle Pines, MN (US)

(21) Appl. No.: 14/799,669

(22) Filed: Jul. 15, 2015

Related U.S. Application Data
(60) Provisional application No. 62/024,514, filed on Jul. 15, 2014.

(51) Int. Cl. F16L 41/02; F16L 41/00; F16L 13/02

(52) U.S. Cl. CPC F16L 41/02; F16L 13/02; F16L 41/004; F16L 41/021; F16L 41/023

(57) ABSTRACT

A fluid manifold includes: a main body defining a fluid pathway; and a plurality of ports coupled to the main body and in fluid communication with the fluid pathway, wherein each of the ports includes a first termination. Each first termination is configured to be coupled to a respective fluid coupler in a fluid tight manner using one or more of the following techniques: overmolding; sonic welding; spin welding; snap joints; heat welding; plastic welding; solvent bonding; vibration welding; and induction welding.

### BACKGROUND

Fluid manifolds allow multiple fluid pathways to be interconnected. A typical manifold is made from a metal or plastic block and is machined, casted, or molded to form the desired fluid pathways therethrough. Connectors are then coupled to the manifold using customized terminations. Such a configuration can be costly and reduce flexibility when forming connections between fluid pathways.

### SUMMARY

In one aspect, a fluid manifold includes: a main body defining a fluid pathway; and a plurality of ports coupled to the main body and in fluid communication with the fluid pathway, wherein each of the ports includes a first termination. Each first termination is configured to be coupled to a respective fluid coupler in a fluid tight manner using one or more of the following techniques: overmolding; sonic welding; spin welding; snap joints; heat welding; plastic welding; solvent bonding; vibration welding; and induction welding.

In another aspect, a fluid manifold assembly includes: a fluid manifold including: a main body defining a fluid pathway; and a plurality of ports coupled to the main body and in fluid communication with the fluid pathway, wherein each of the ports includes a first termination having a protrusion and a groove; and a plurality of fluid couplers, wherein each of the fluid couplers includes: a body defining a fluid pathway therethough; and a second termination having a protrusion and a groove; wherein each of the fluid couplers is coupled to one of the ports of the fluid manifold by positioning the protrusion of the first termination into the groove of the second termination, and the protrusion of the second termination into the groove of the first termination; and wherein an overmold seal is formed between each of the first and second terminations to create a fluid tight seal therebetween.

### DESCRIPTION OF THE DRAWINGS

Reference is now made to the accompanying drawings, which are not necessarily drawn to scale.

FIG. 1 is a perspective view of an example fluid manifold assembly.

FIG. 2 is a top view of the fluid manifold assembly of FIG. 1.

FIG. 3 is an end view of the fluid manifold assembly of FIG. 1.

FIG. 4 is another end view of the fluid manifold assembly of FIG. 1.

FIG. 5 is a cross-sectional view of the fluid manifold assembly of FIG. 1.

FIG. 6 is a perspective view of an example fluid manifold of the fluid manifold assembly of FIG. 1.

FIG. 7 is a top view of the fluid manifold of FIG. 6.

FIG. 8 is an end view of the fluid manifold of FIG. 6.

FIG. 9 is another end view of the fluid manifold of FIG. 6.

FIG. 10 is a cross-sectional view of the fluid manifold of FIG. 6.

FIG. 11 is a perspective view of another example fluid manifold assembly.

FIG. 12 is a top view of the fluid manifold assembly of FIG. 11.

FIG. 13 is an end view of the fluid manifold assembly of FIG. 11.

FIG. 14 is another end view of the fluid manifold assembly of FIG. 11.

FIG. 15 is a cross-sectional view of the fluid manifold assembly of FIG. 11.

FIG. 16 is a perspective view of an example fluid manifold of the fluid manifold assembly of FIG. 11.

FIG. 17 is a top view of the fluid manifold of FIG. 16.

FIG. 18 is an end view of the fluid manifold of FIG. 16.

FIG. 19 is another end view of the fluid manifold of FIG. 16.

FIG. 20 is a cross-sectional view of the fluid manifold of FIG. 16.

FIG. 21 is a perspective view of another example fluid manifold assembly.

FIG. 22 is a top view of the fluid manifold assembly of FIG. 21.

FIG. 23 is an end view of the fluid manifold assembly of FIG. 21.

FIG. 24 is another end view of the fluid manifold assembly of FIG. 21.

FIG. 25 is a cross-sectional view of the fluid manifold assembly of FIG. 21.

FIG. 26 is a perspective view of an example fluid manifold of the fluid manifold assembly of FIG. 21.

FIG. 27 is a top view of the fluid manifold of FIG. 26.

FIG. 28 is an end view of the fluid manifold of FIG. 26.

FIG. 29 is another end view of the fluid manifold of FIG. 26.

FIG. 30 is a cross-sectional view of the fluid manifold of FIG. 26.

FIG. 31 is a perspective view of another example fluid manifold assembly.

FIG. 32 is a top view of the fluid manifold assembly of FIG. 31.

FIG. 33 is an end view of the fluid manifold assembly of FIG. 31.

FIG. 34 is another end view of the fluid manifold assembly of FIG. 31.

FIG. 35 is a cross-sectional view of the fluid manifold assembly of FIG. 31.

FIG. 36 is an enlarged cross-sectional view of a portion of the fluid manifold assembly of FIG. 35.

FIG. 37 is a perspective view of an example fluid manifold of the fluid manifold assembly of FIG. 31.

FIG. 38 is a top view of the fluid manifold of FIG. 37.

FIG. 39 is an end view of the fluid manifold of FIG. 37.

FIG. 40 is another end view of the fluid manifold of FIG. 37.

FIG. 41 is a cross-sectional view of the fluid manifold of FIG. 37.

### DETAILED DESCRIPTION

The present disclosure relates to fluid manifold assemblies used to interconnect multiple fluid pathways.

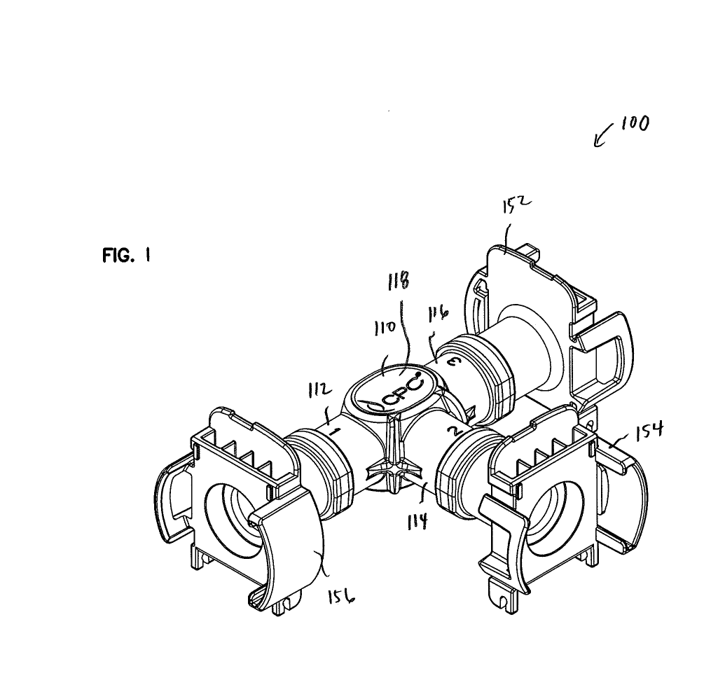

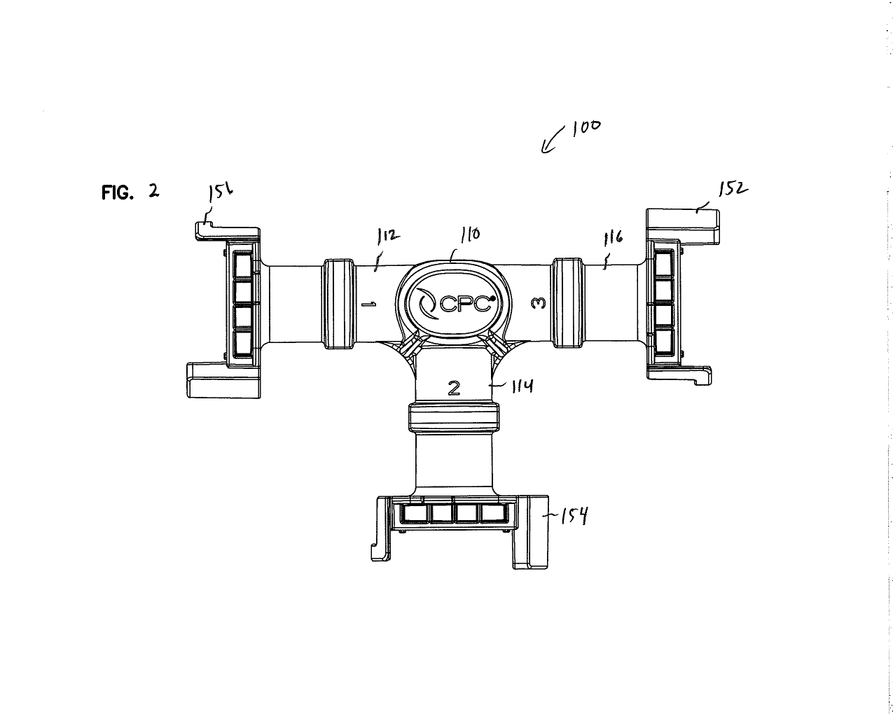

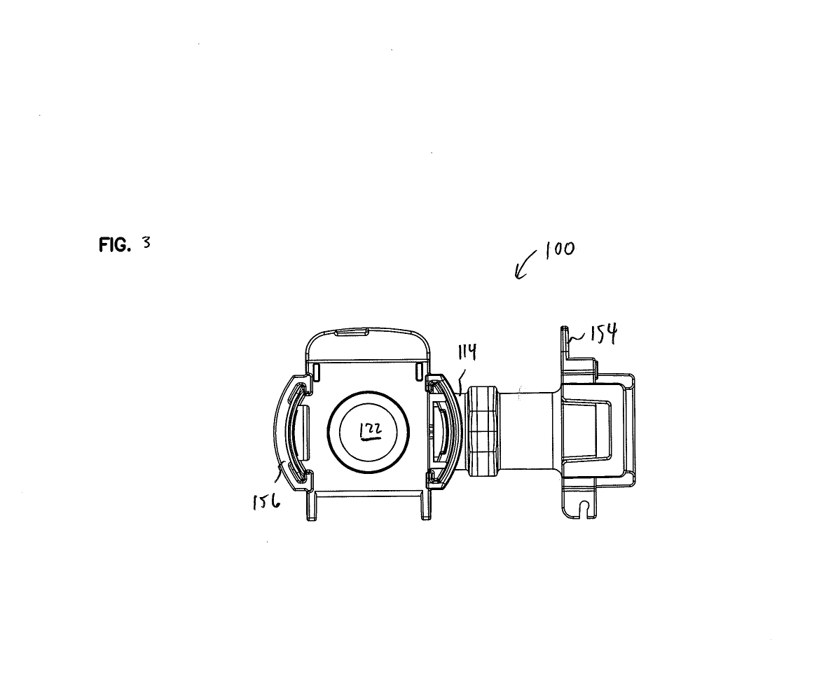

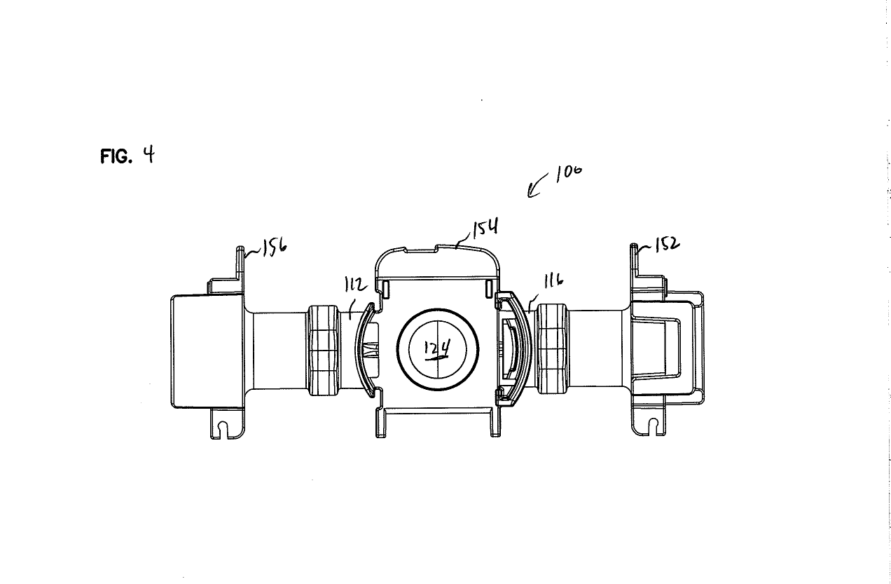

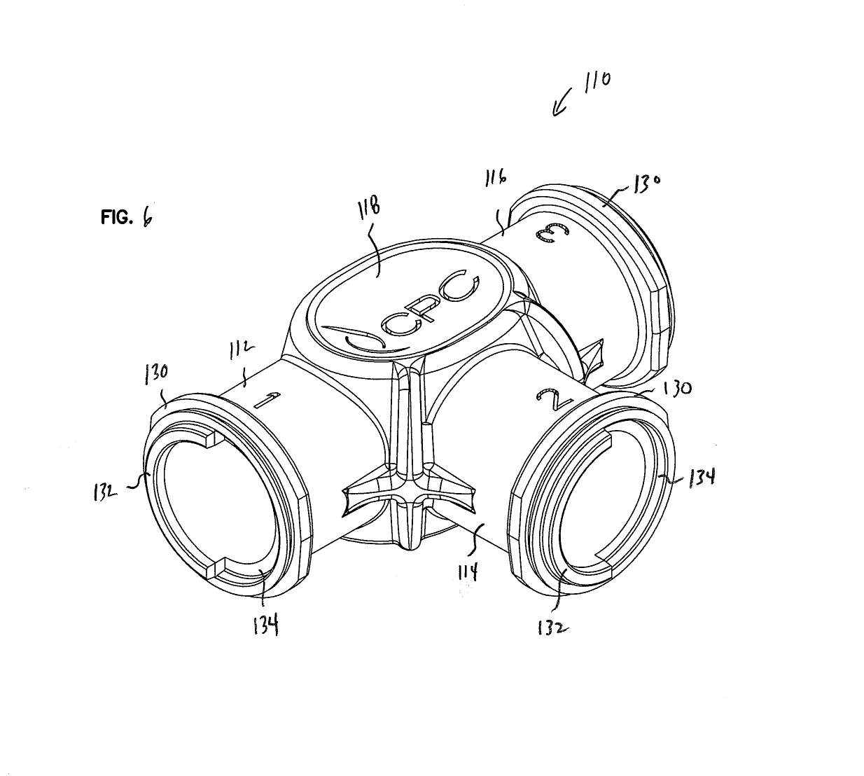

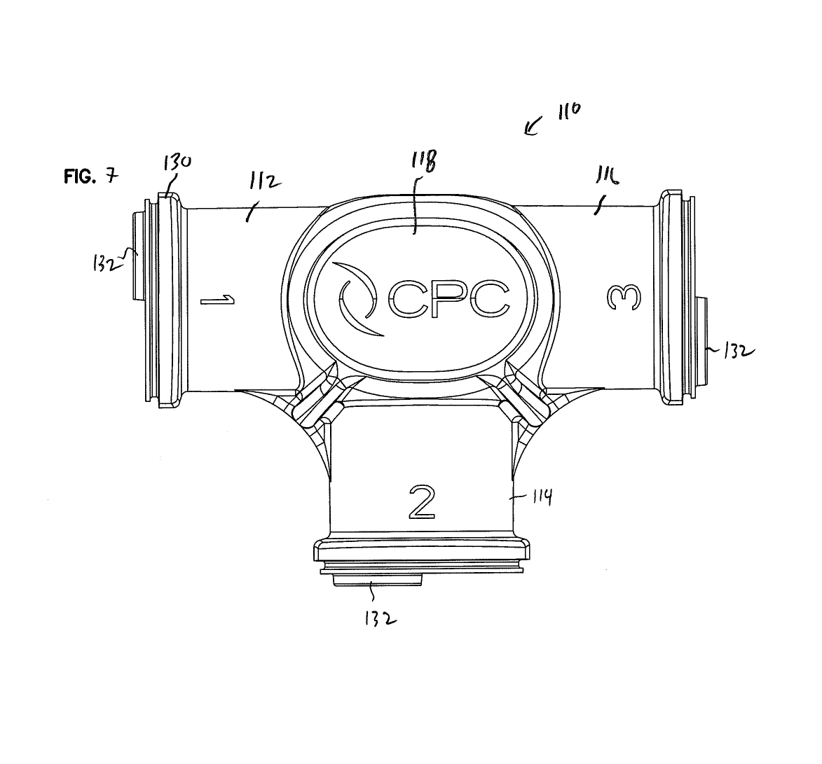

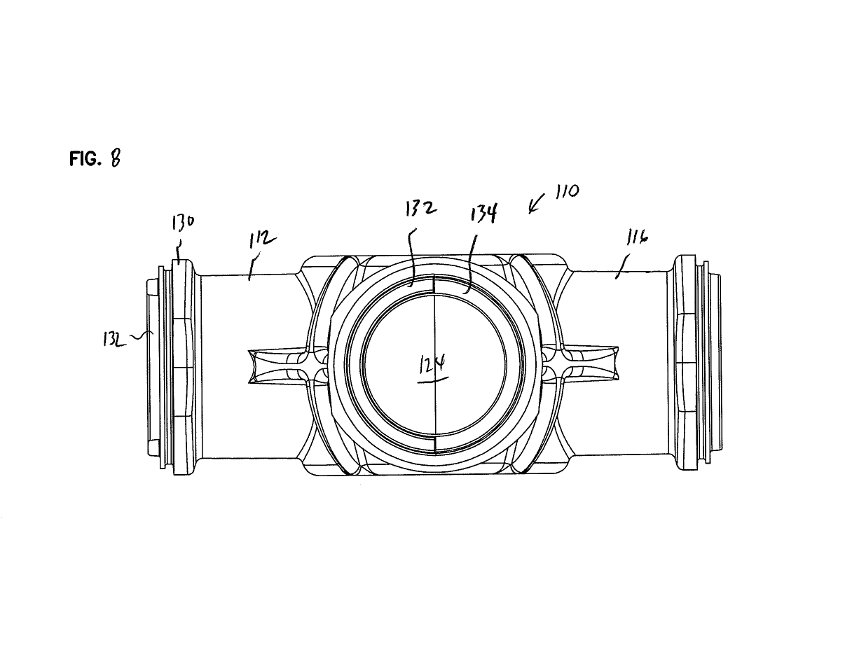

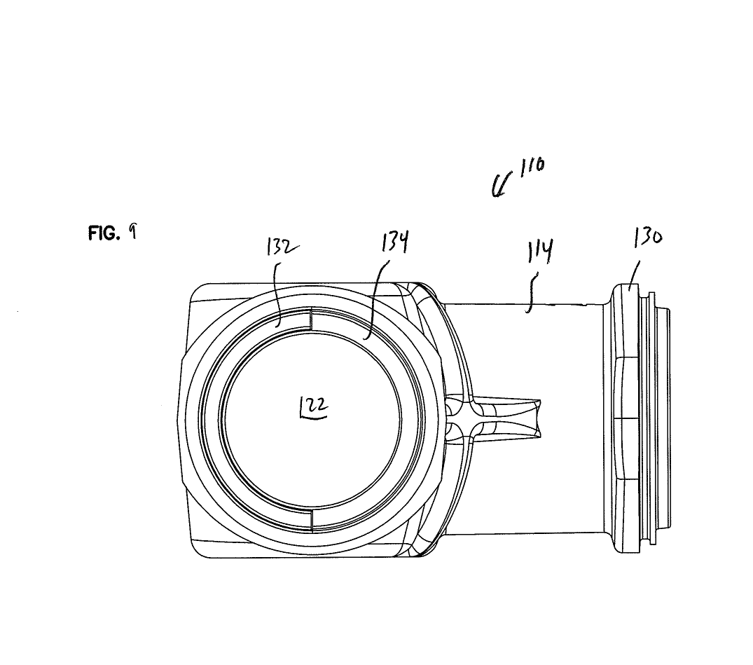

Referring now to FIGS. 1-10, an example fluid manifold assembly 100 is shown. In this embodiment, the fluid manifold assembly 100 includes a fluid manifold 110 and fluid couplers 152, 154, 156 attached thereto. As described further below, the fluid couplers 152, 154, 156 are configured to be connected to fluid pathways (e.g., fluid lines), and the fluid manifold 110 facilitates the interconnection of those fluid pathways.

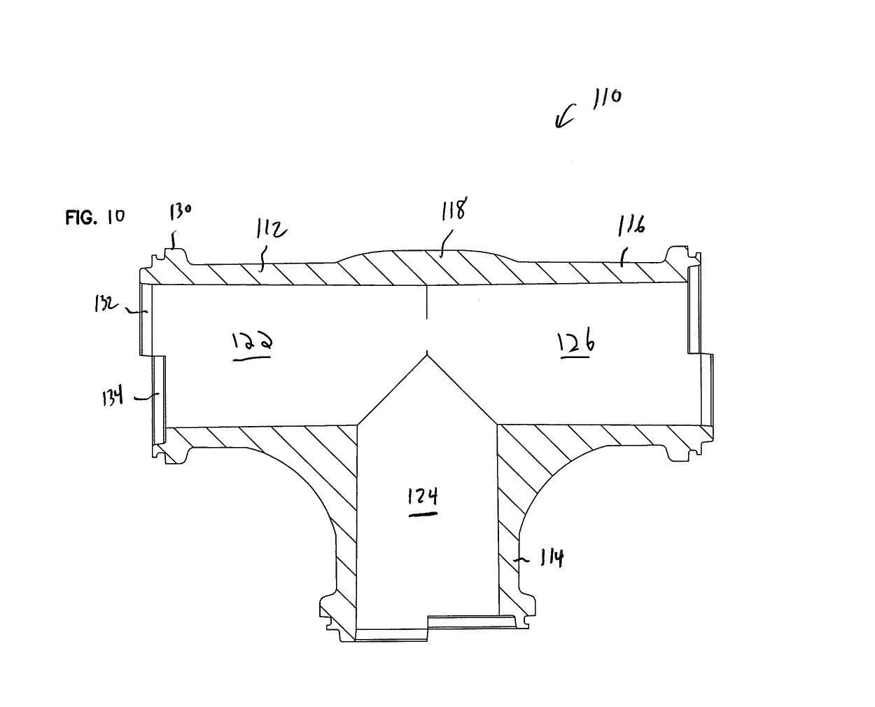

The fluid manifold 110 includes a main body 118 and ports 112, 114, 116. In this configuration, the fluid manifold 110 provides a first fluid pathway 122 through the port 112, to the main body 118, a second fluid pathway 124 through the port 114 to the main body 118, and a third fluid pathway 126 through the port 116 to the main body 118. The first and third fluid pathways 122, 126 are axially aligned and perpendicular to the second fluid pathway 124. See FIG. 10. Fluid can flow into and out of the ports 112, 114, 116 and is mixed in the main body 118. For example, in one scenario, the port 114 can allow fluid to flow therein through the second fluid pathway 124, and the ports 112, 116 can allow fluid to flow thereout through the first and third fluid pathways 122, 126.

Each of the ports 112, 114, 116 includes a termination 130. The termination 130 is configured to be connected to a fluid coupler, such as fluid couplers 152, 154, 156. Specifically, the termination 130 includes a protrusion 132 and a groove 134.

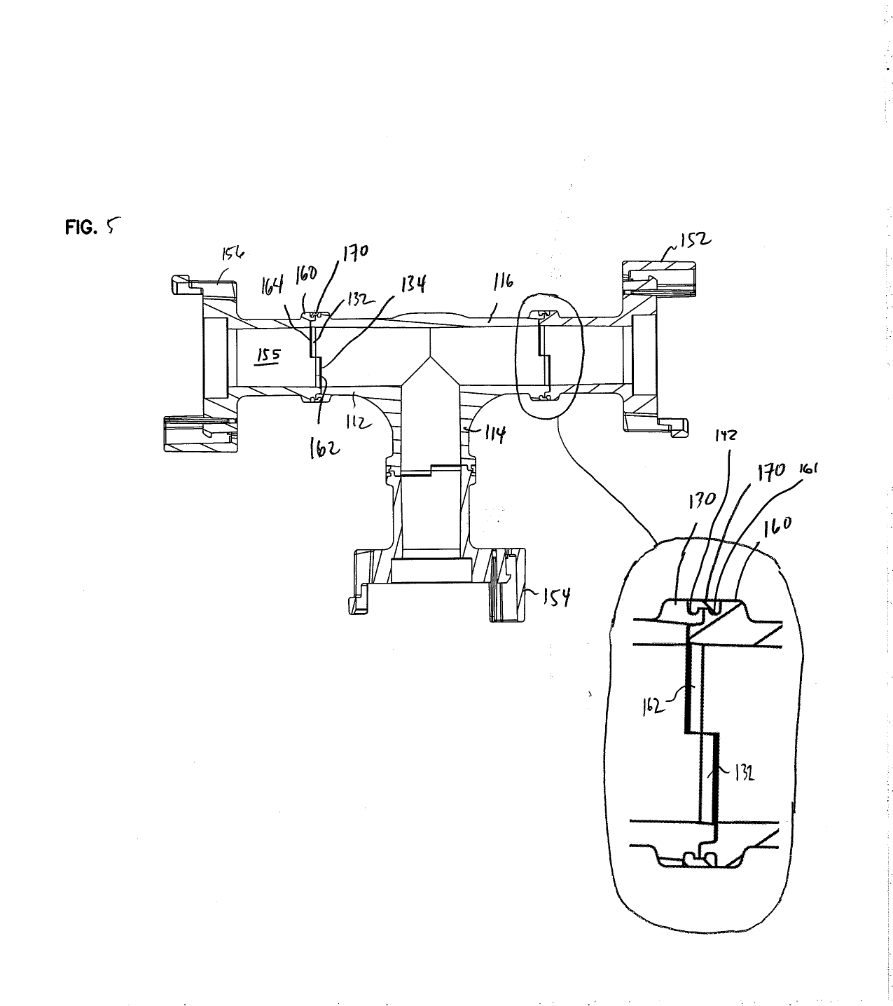

The termination 130 is standardized or universal so that multiple different fluid couplers with a mating termination can be coupled thereto. For example, as shown in FIG. 5, each of the mating fluid couplers 152, 154, 156 includes a fluid pathway 155 and a termination 160. The termination 160 includes a protrusion 162 and a groove 164 that correspond to the groove 134 and the protrusion 132 of the termination 130 of the fluid manifold 110.

When joined, the protrusion 162 is received in the groove 134, and the protrusion 132 is received in the groove 164 in a lap joint (or tongue-in-groove) fashion. In this configuration, terminations 130, 160 are raised to form a flange configuration that forms a cavity. An overmolded joint 170 is formed in the cavity between the termination 130 and the termination 160 of the fluid coupler 152, 154, 156 around the entire diameter of the terminations 130, 160 to form a fluid tight seal and mechanical connection or joint between the manifold and the fluid coupler.

For example, as shown in FIG. 5, the termination 130 forms a first half trough 142, and the termination 160 forms a second half trough 161. When connected, the first and second half troughs 142, 161 form the area into which the overmolded joint 170 is formed. The overmolded joint 170 assures a fluid tight seal between the terminations 130, 160.

In the example shown, the fluid manifold 110 and the fluid couplers 152, 154, 156 are molded from a polymeric material, such as polycarbonate or polysulfone. Likewise, the overmolded joint 170 is made of the same or similar material and is formed using an overmolding or insert molding process.

An example method of manufacture and use for the fluid manifold assembly 100 is as follows. Initially, the fluid manifold and the fluid couplers are formed using a known technique, such as injection molding. As previously noted, the fluid couplers are formed with the standardized termination that allows the fluid couplers to be easily coupled (e.g., pressed or snapped and/or pressed together by hand or using a tool) to the fluid manifold.

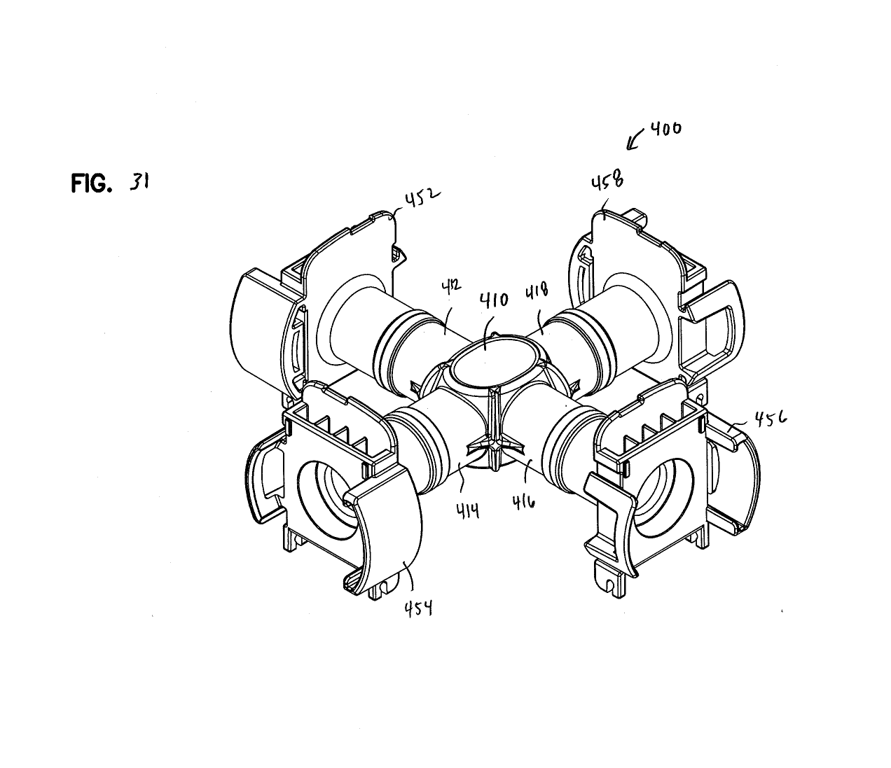

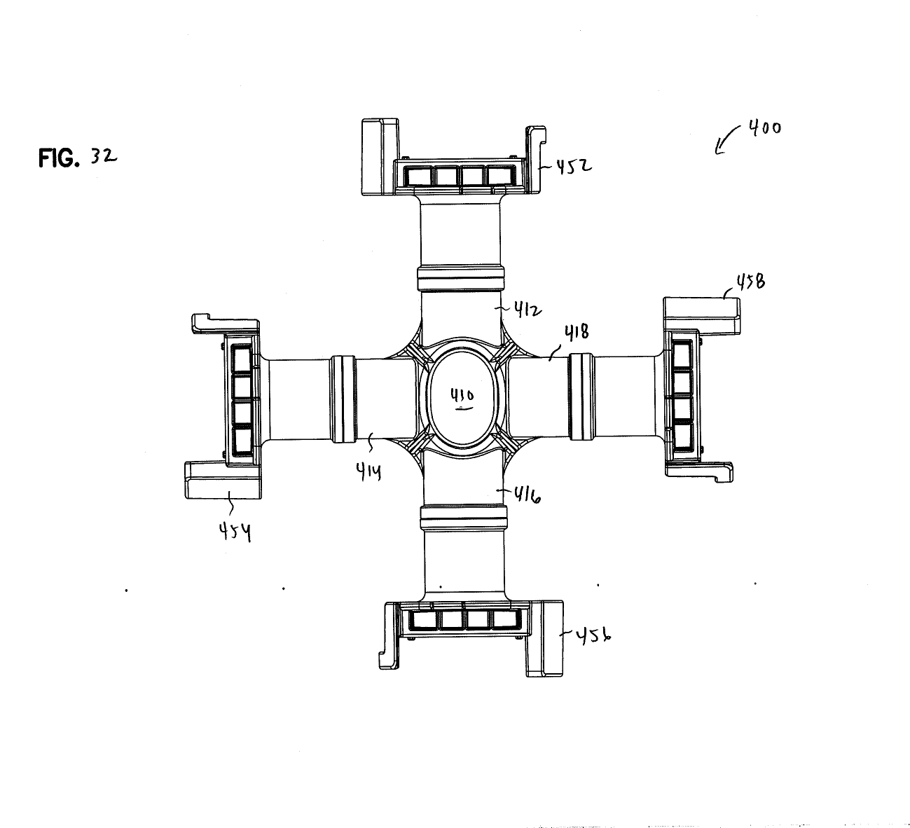

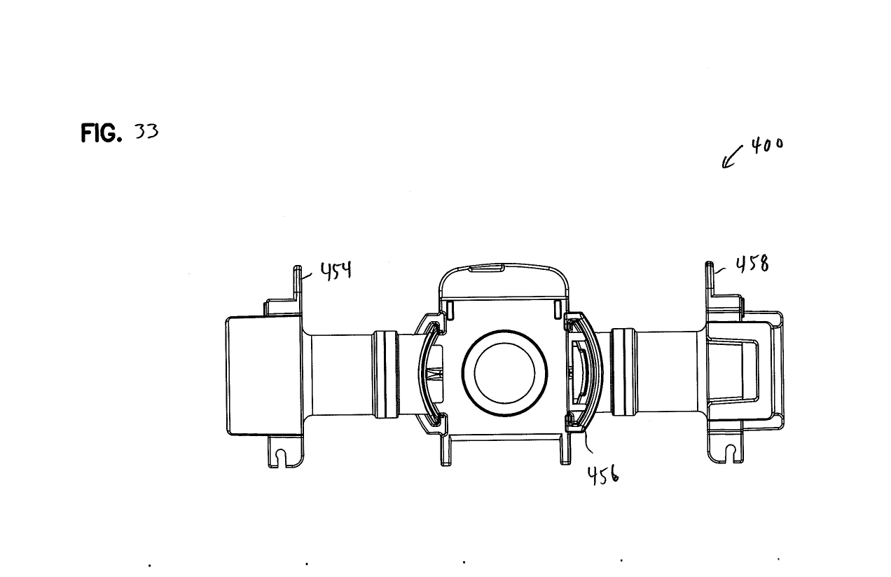

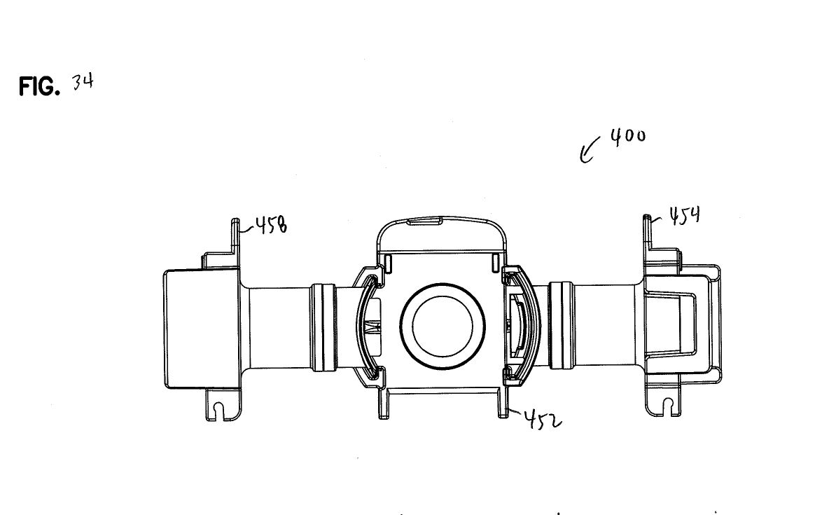

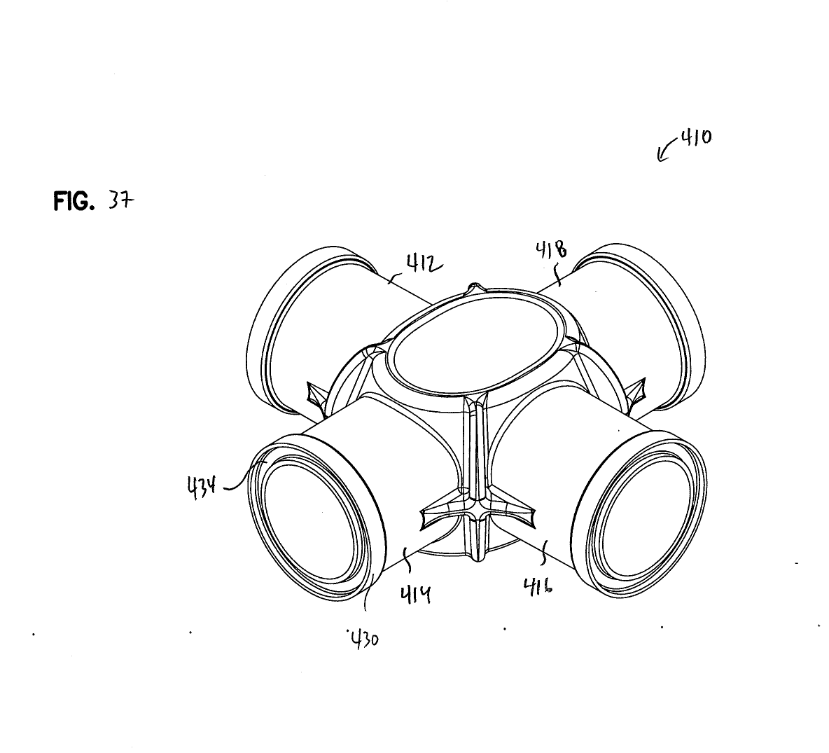

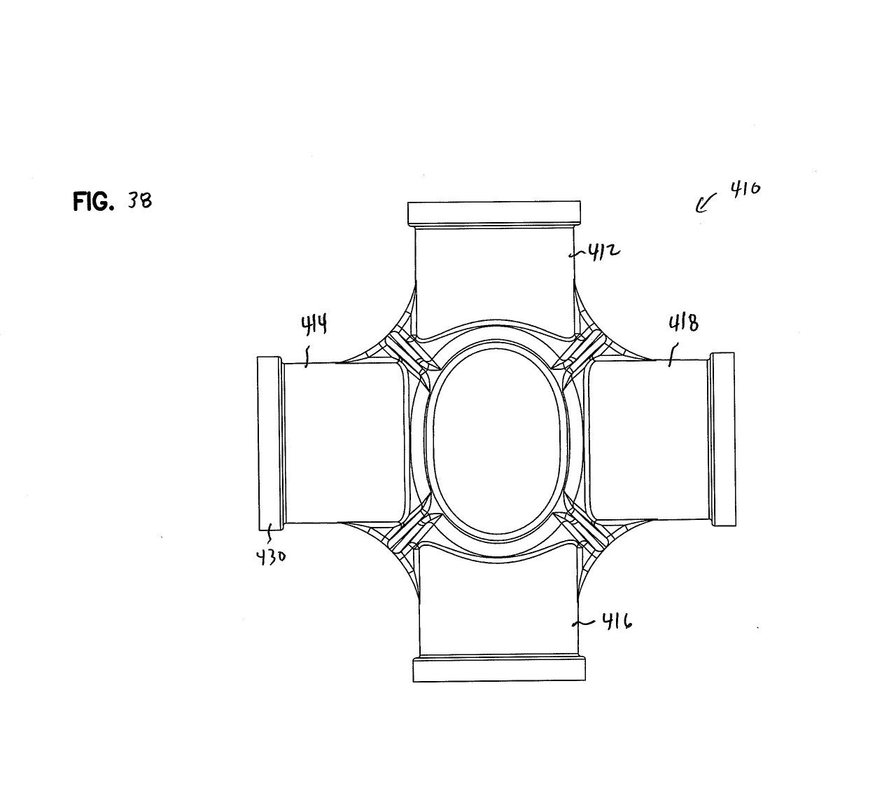

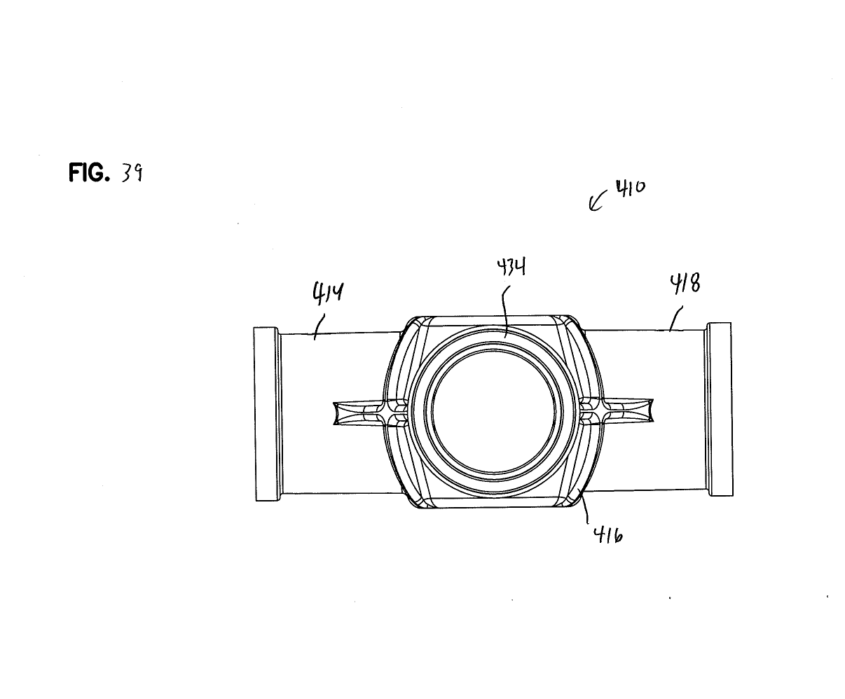

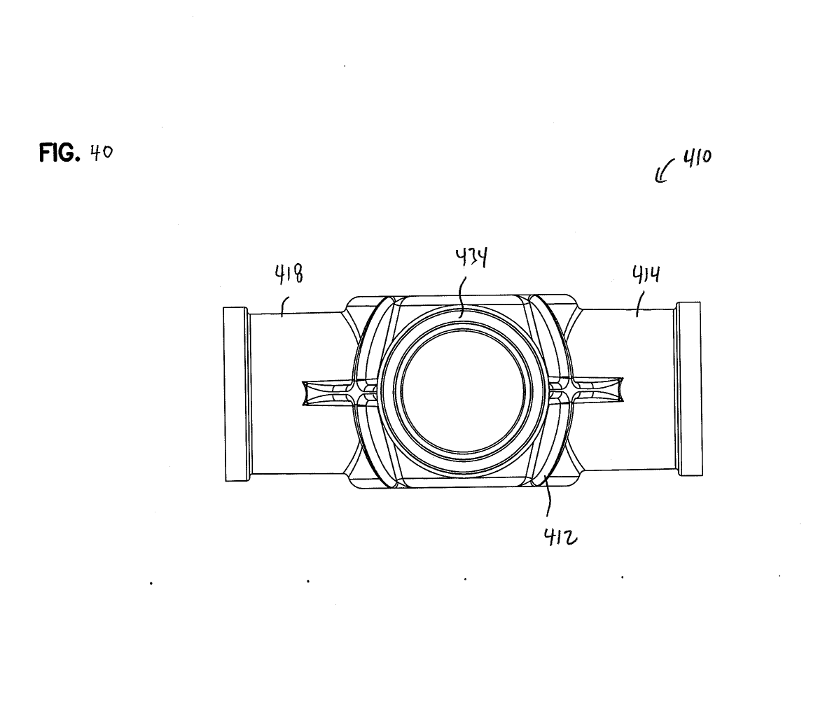

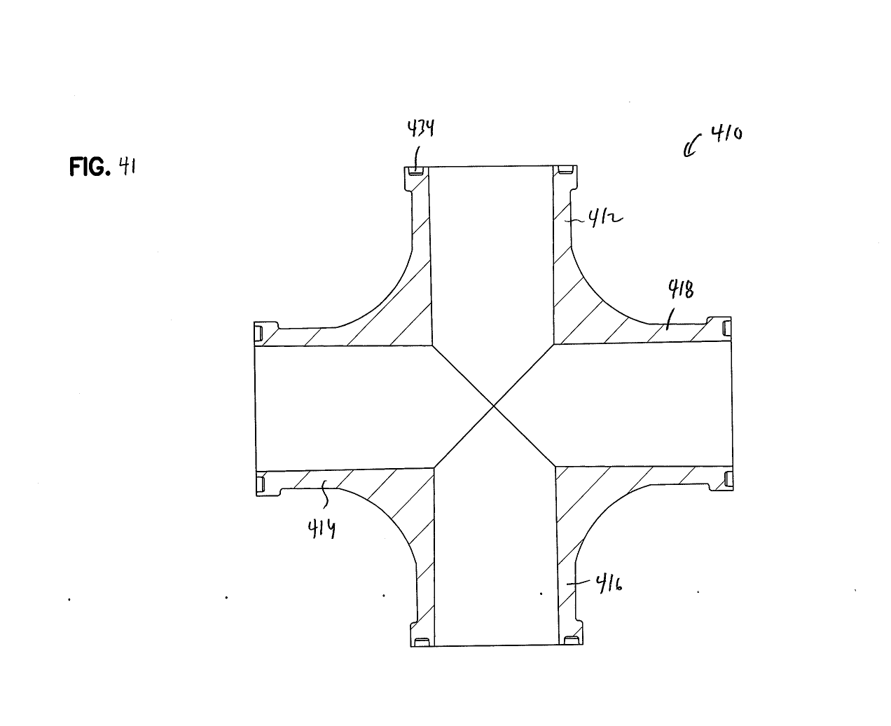

Next, the fluid couplers are attached to the fluid manifold using a known technique, such as the overmolding process described herein. However, other techniques, such as sonic welding (see FIGS. 31-41) or any other process that provides a mechanical and leak free connection, could also be used. Examples of other process that can be used include: spin welding, snap joints; heat welding (fusion bonding), plastic welding (hot-gas welding), threaded joints, solvent bonding, vibration welding, and induction welding. This list is not exhaustive. In some embodiments, the fluid couplers and/or the fluid manifold can be sterilized using known techniques, such as steam or gamma sterilization. Finally, the fluid couplers are connected to sources and destinations of fluid, and fluid is allowed to enter and exit the ports of the fluid manifold.

In the example shown, the fluid couplers 152, 154, 156 are aseptic coupling devices, such as those described in U.S. patent application Ser. No. 13/800,630 filed on Mar. 13, 2013, the entirety of which is hereby incorporated by reference. However, other types of fluid couplers can be used. For example, the fluid couplers described in U.S. Pat. No. 7,547,047 to deCler et al. and U.S. Pat. No. 5,104,158 to Meyer et al., the entirety of which are hereby incorporated by reference, can be used. A standard connection can be made by forming the termination of each of the fluid couplers to include the protrusion and groove described above (or other standard geometries).

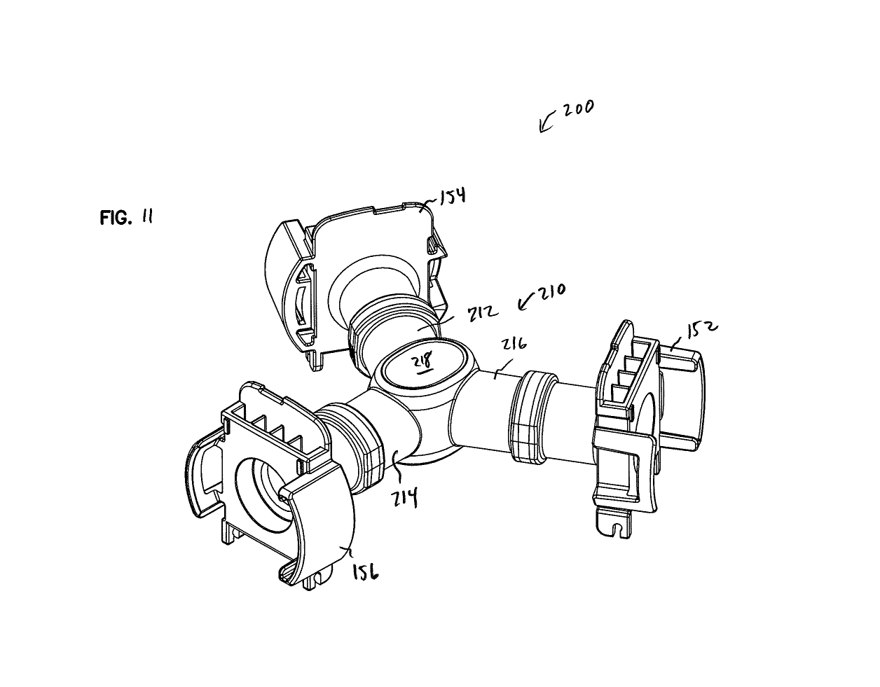

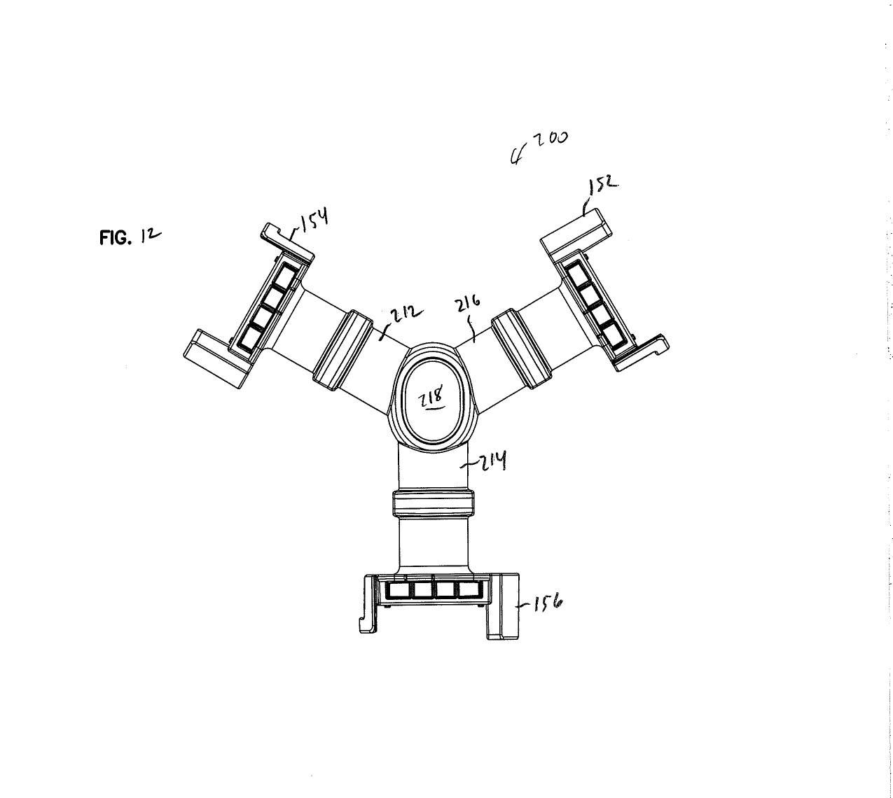

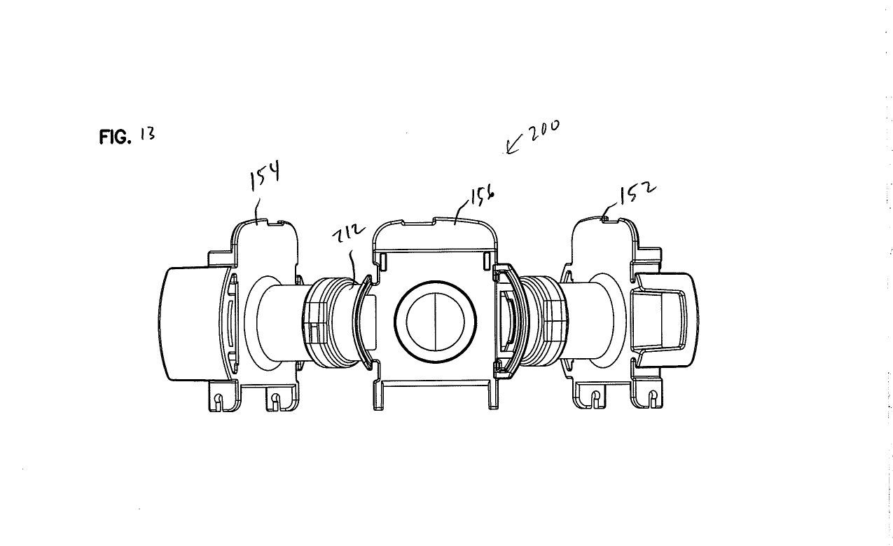

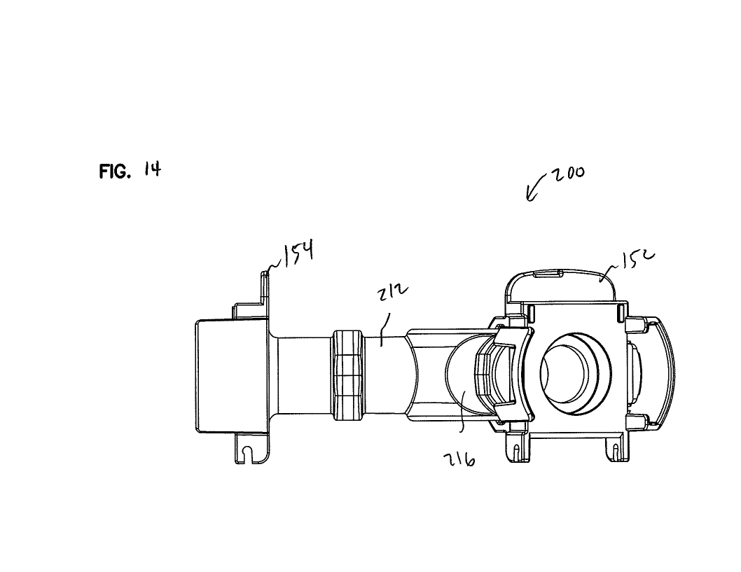

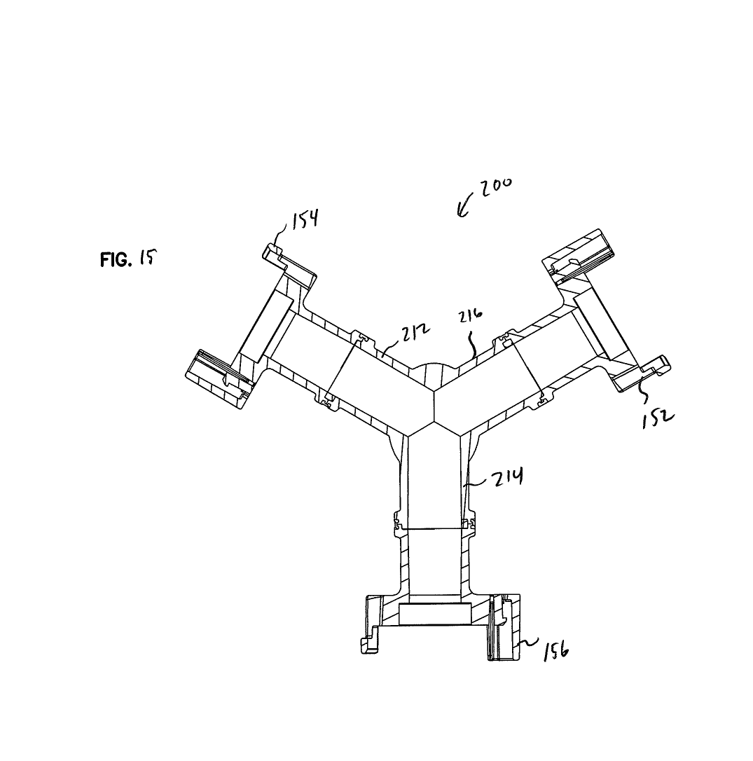

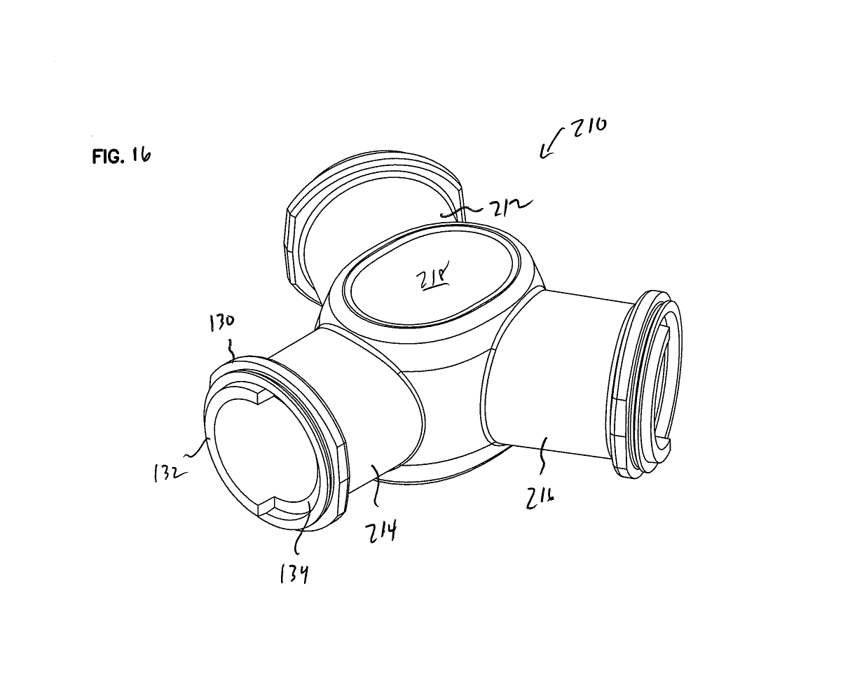

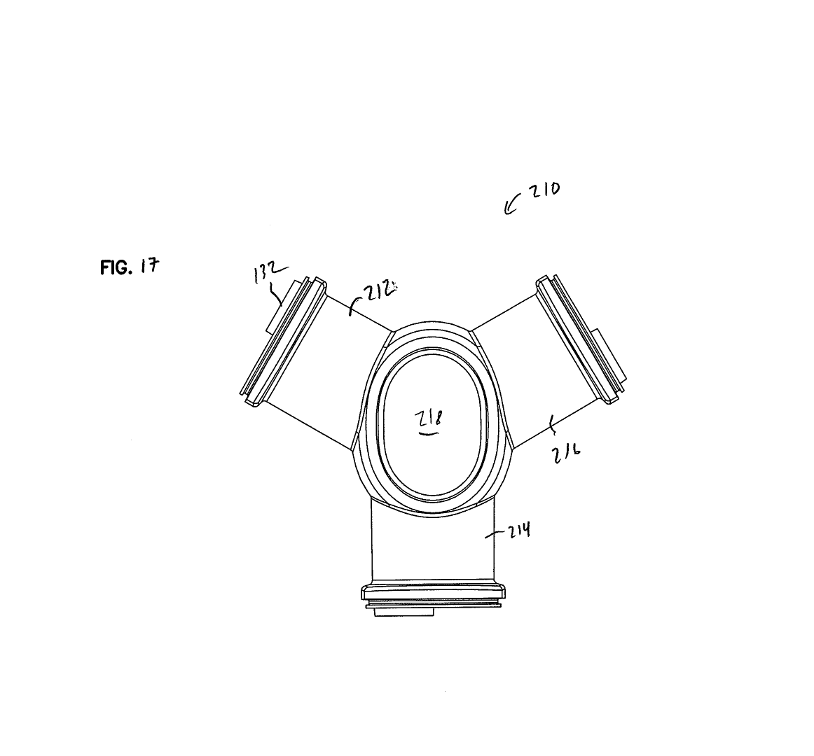

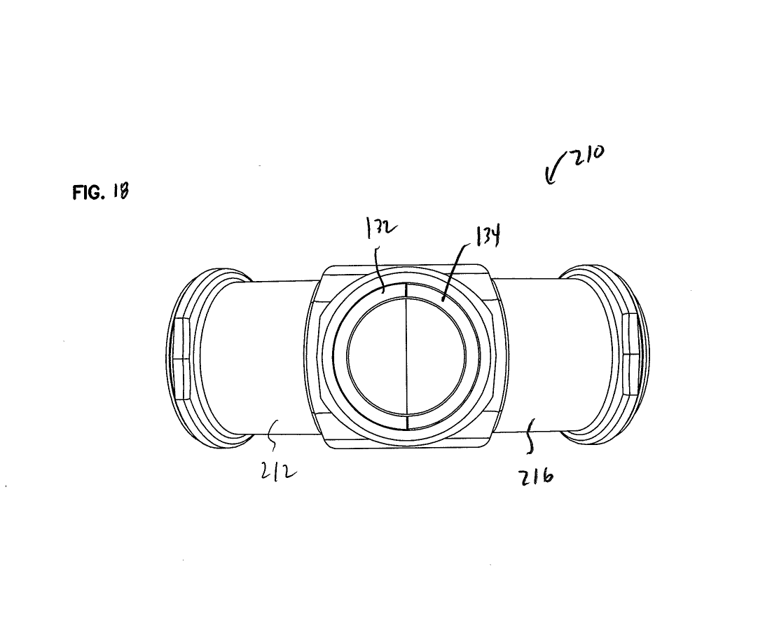

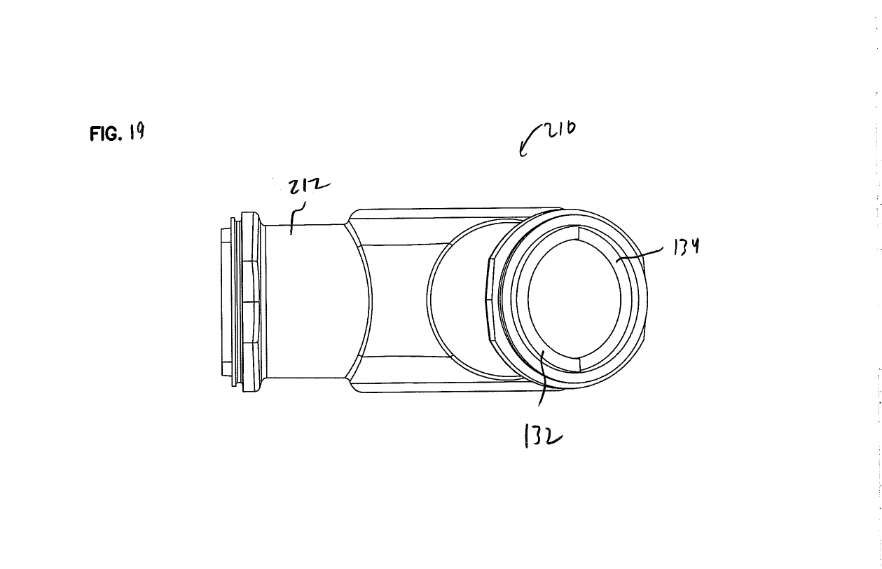

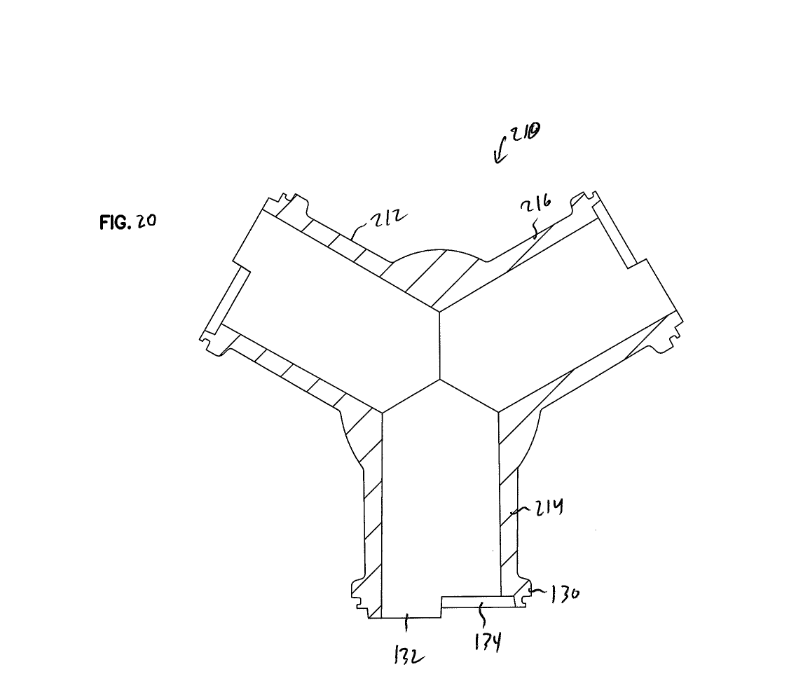

In addition, the fluid manifold can be formed in many different configurations. For example, as shown in FIGS. 11-20, another example fluid manifold assembly 200 is shown. In this embodiment, ports 212, 214, 216 are formed at regular angles about a main body 218 of a fluid manifold 210 of the fluid manifold assembly 200. Specifically, the ports 212, 214, 216 are each spaced 120 degrees from the adjacent port. Many other configurations on how the ports are formed on the main body 218 can be used.

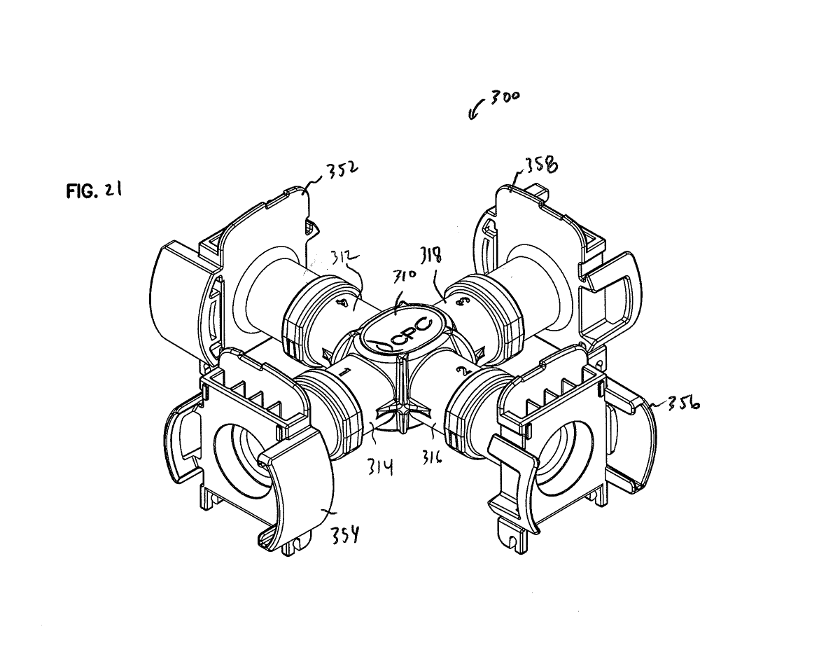

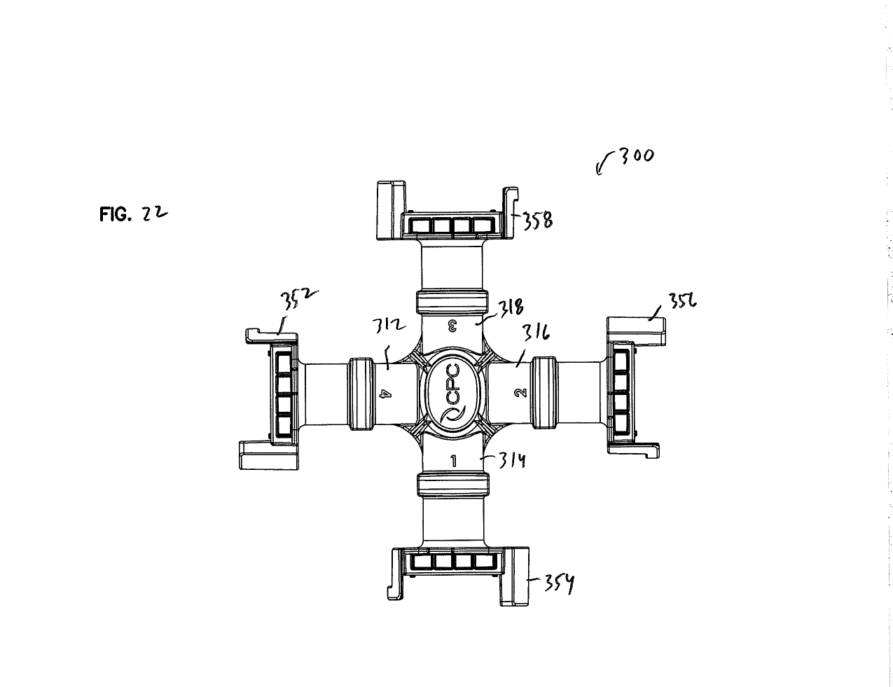

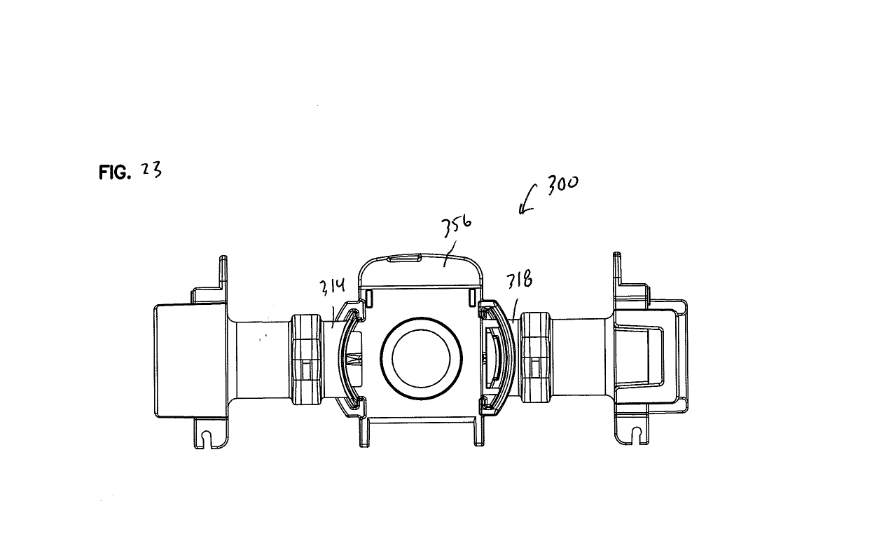

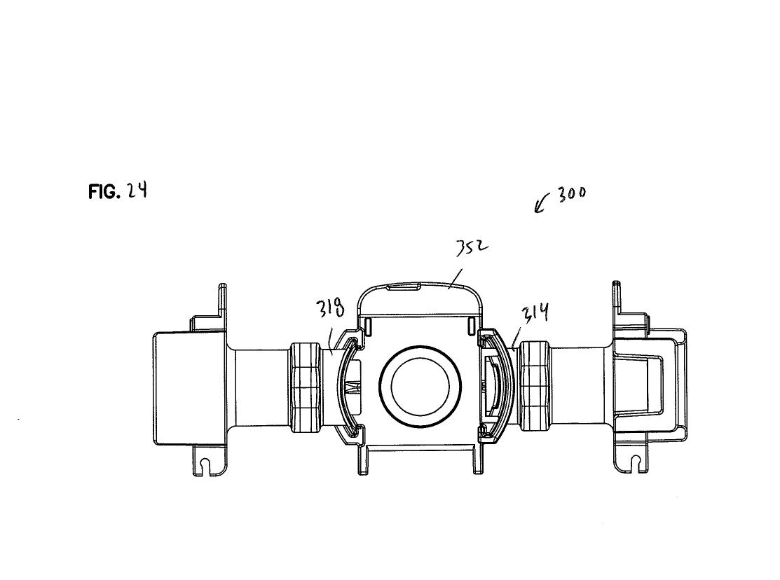

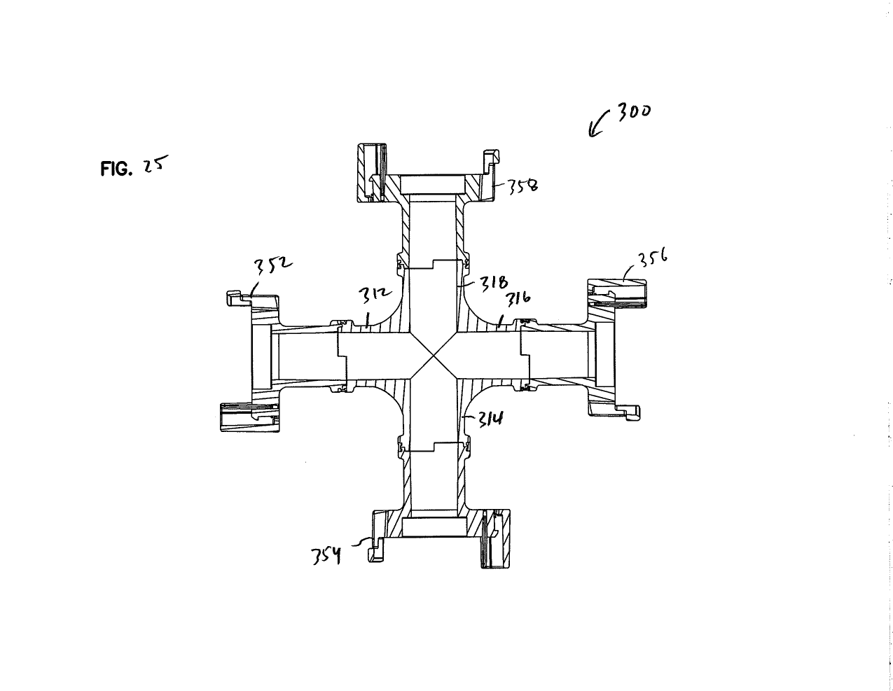

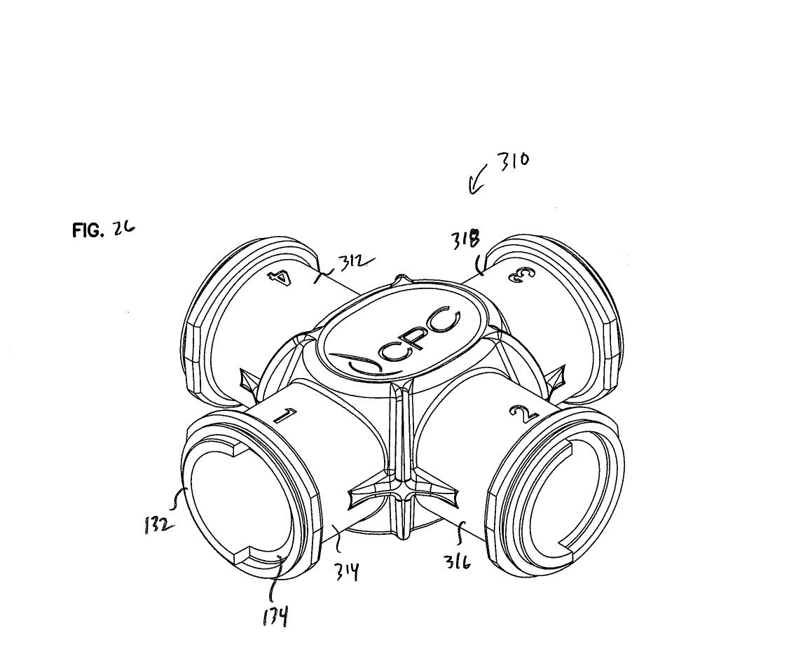

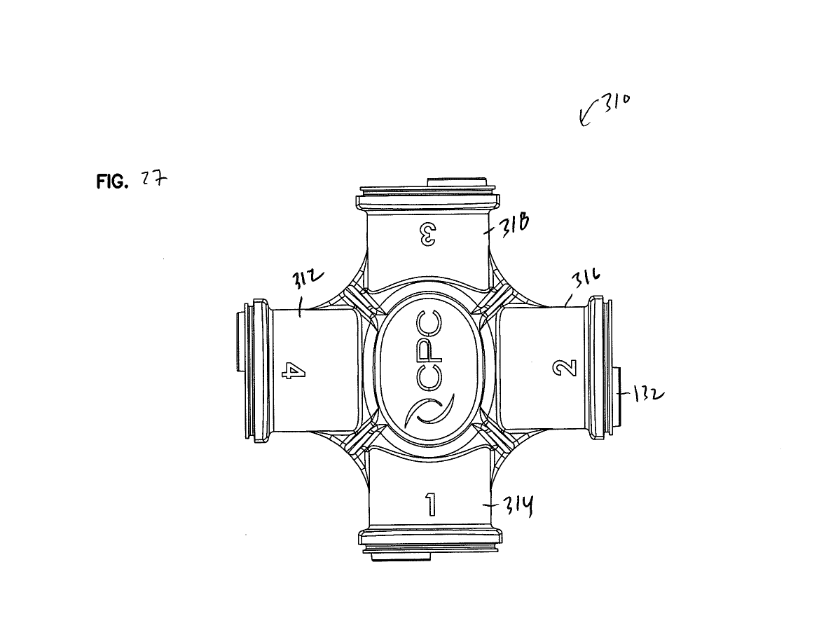

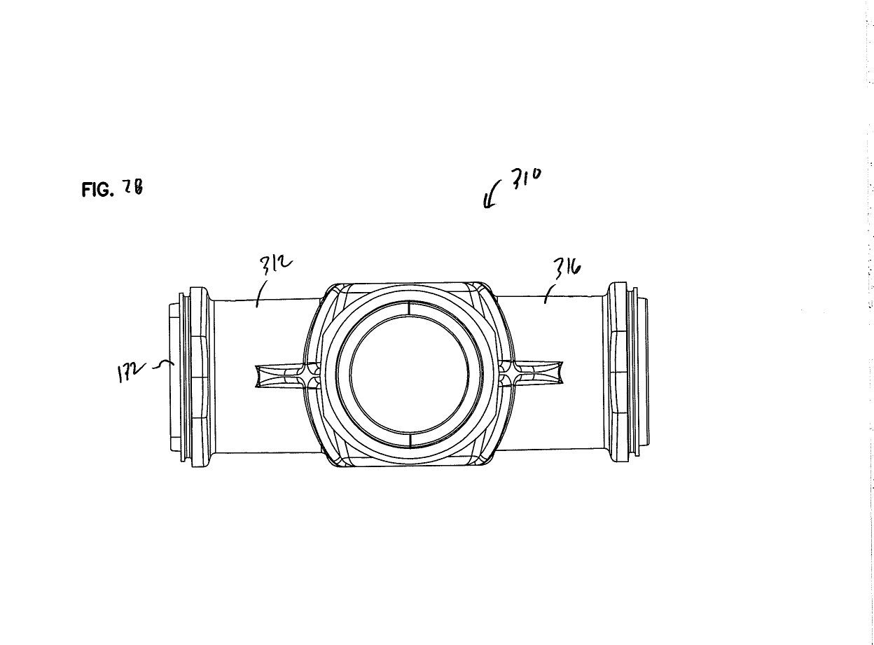

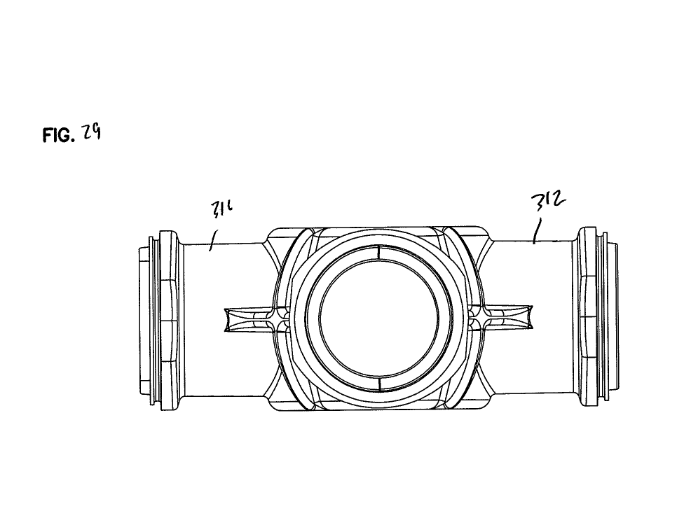

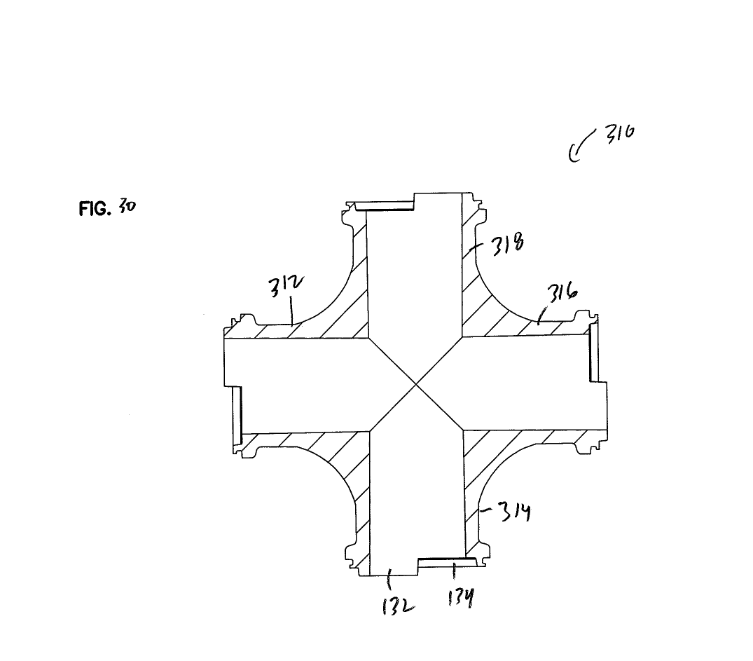

In addition, more or fewer ports can be used. For example, referring now to FIGS. 21-30, another example fluid manifold assembly 300 is shown. In this embodiment, the fluid manifold assembly 300 includes a main body 310 and four ports 312, 314, 316, 318. Fluid couplers 352, 354, 356, 358 are coupled to the ports 312, 314, 316, 318.

Referring now to FIGS. 31-41, another example fluid manifold assembly 400 is shown. The fluid manifold assembly is similar in construction to that of the fluid manifold assembly 300 described above. In this embodiment, the fluid manifold assembly 400 includes a main body 410 and four ports 412, 414, 416, 418. Fluid couplers 452, 454, 456, 458 are coupled to the ports 412, 414, 416, 418.

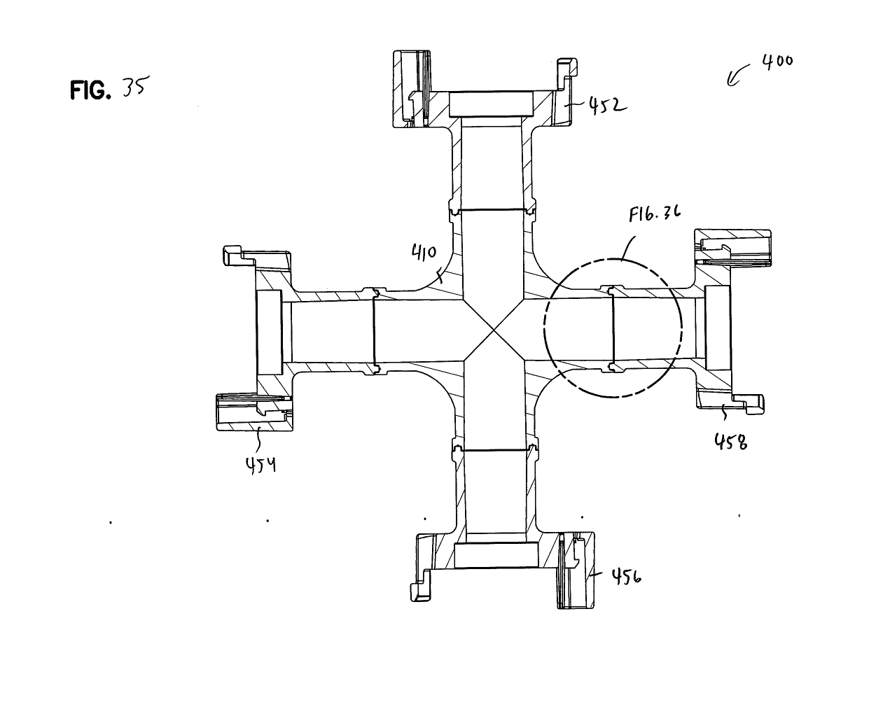

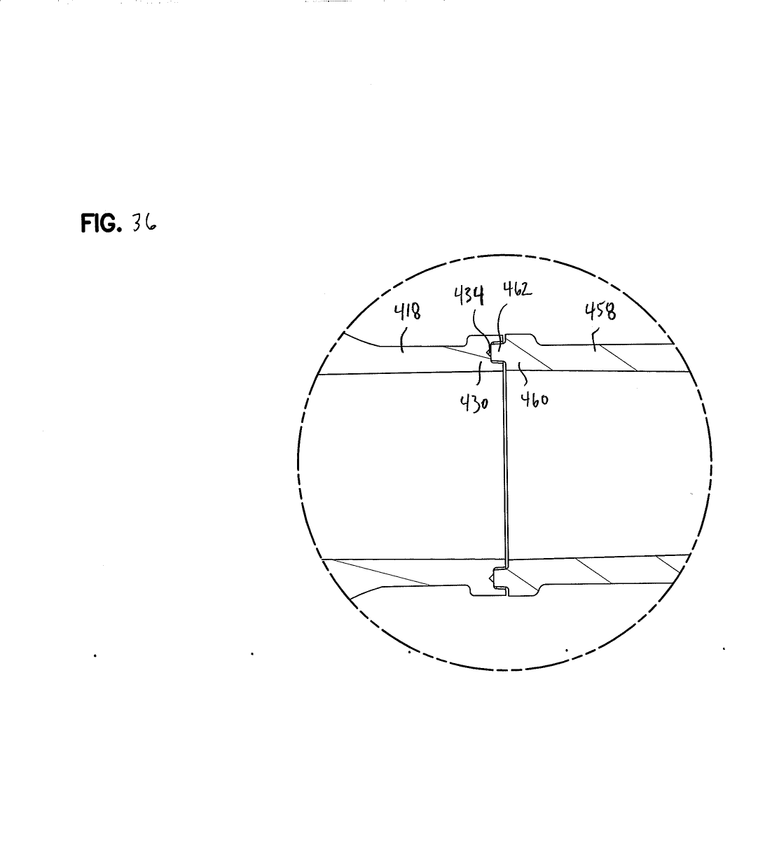

A termination 430 of each of the ports 412, 414, 416, 418 includes a groove 434. A termination 460 of each of the fluid couplers 452, 454, 456, 458 includes a protrusion 462. As shown, for example, in FIGS. 35-36, when joined, the protrusion 462 is received in the groove 434. In this configuration, the protrusion 462 is sonic welded within the groove 434 to form a fluid tight seal between the manifold 410 and the fluid coupler 458.

Alternative designs are possible. For example, the protrusion can be provided on the termination of each of the ports, and the groove can be provided on the termination of each of the fluid couplers.

In other alternative designs, more or fewer ports can be provided. For example, manifold assemblies with two ports, three ports, four ports, five ports, six ports, seven ports, eight ports, nine ports, ten ports, or more can be formed. Further, manifold assemblies can be daisy-chained together to form larger assemblies. If manifold assemblies are daisy-chained, an adapter can be overmolded onto one of the ports of one manifold to allow that port to interface with a port of another manifold. In addition, as previously noted, the positions of the ports about the main body of the manifold assembly can be modified as needed to provide desired space and fluid flow characteristics.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A fluid manifold, comprising:
a main body defining a fluid pathway; and
a plurality of ports coupled to the main body and in fluid communication with the fluid pathway, wherein each of the ports includes a first termination;
wherein each first termination is configured to be coupled to a respective fluid coupler in a fluid tight manner using one or more of the following techniques: overmolding; sonic welding; spin welding; snap joints; heat welding; plastic welding; solvent bonding; vibration welding; and induction welding.

2. The fluid manifold of claim 1, wherein each first termination defines a groove sized to receive a protrusion of the respective fluid coupler therein.

3. The fluid manifold of claim 1, wherein each first termination has a groove and a protrusion sized to be coupled to a corresponding groove and protrusion of the respective fluid coupler.

4. The fluid manifold of claim 3, wherein the fluid manifold includes three or more ports.

5. The fluid manifold of claim 1, wherein the fluid manifold includes three or more ports.

6. The fluid manifold of claim 1, wherein the manifold is sterilized.

7. The fluid manifold of claim 1, wherein the fluid coupler is an aseptic coupling device.

8. A fluid manifold assembly, comprising:
a fluid manifold including:
a main body defining a fluid pathway; and
a plurality of ports coupled to the main body and in fluid communication with the fluid pathway, wherein each of the ports includes a first termination; and
a plurality of fluid couplers, wherein each of the fluid couplers includes:
a body defining a fluid pathway therethough; and
a second termination;
wherein each of the fluid couplers is coupled to one of the ports of the fluid manifold by coupling the first termination to the second termination by one or more of the following techniques: overmolding; sonic welding; spin welding; snap joints; heat welding; plastic welding; solvent bonding; vibration welding; and induction welding

9. The fluid manifold assembly of claim 8, wherein an overmolded joint is formed between each of the first and second terminations to create a fluid tight seal therebetween.

10. The fluid manifold assembly of claim 8, wherein each first termination defines a groove sized to receive a protrusion of the respective fluid coupler therein.

11. The fluid manifold assembly of claim 8, wherein each first termination has a groove and a protrusion sized to be coupled to a corresponding groove and protrusion of the respective fluid coupler.

12. The fluid manifold assembly of claim 11, wherein the fluid manifold includes three or more ports.

13. The fluid manifold assembly of claim 8, wherein the fluid manifold includes three or more ports.

14. The fluid manifold assembly of claim 8, wherein the manifold is sterilized.

15. The fluid manifold assembly of claim 8, wherein the fluid coupler is an aseptic coupling device.

16. A fluid manifold assembly, comprising:
a fluid manifold including:
a main body defining a fluid pathway; and
a plurality of ports coupled to the main body and in fluid communication with the fluid pathway, wherein each of the ports includes a first termination having a protrusion and a groove; and
a plurality of fluid couplers, wherein each of the fluid couplers includes:
a body defining a fluid pathway therethough; and
a second termination having a protrusion and a groove;
wherein each of the fluid couplers is coupled to one of the ports of the fluid manifold by positioning the protrusion of the first termination into the groove of the second termination, and the protrusion of the second termination into the groove of the first termination; and
wherein an overmolded joint is formed between each of the first and second terminations to create a fluid tight seal therebetween.

17. The fluid manifold assembly of claim 16, wherein the fluid manifold includes three or more ports.

18. The fluid manifold assembly of claim 16, wherein the fluid manifold includes four or more ports.

19. The fluid manifold assembly of claim 16, wherein the manifold is sterilized.

20. The fluid manifold assembly of claim 16, wherein the fluid coupler is an aseptic coupling device.
